(19) United States
(12) Patent Application Publication
(10) Pub. No.: US 2024/0181755 A1
(43) Pub. Date: Jun. 6, 2024

(54) ARTICLE, IN PARTICULAR FOR AN AIR SPRING BELLOWS

(71) Applicant: ContiTech Deutschland GmbH, Hannover (DE)

(72) Inventors: Thorsten Leethaus, Eschershausen (DE); Dieter Borvitz, Hannover (DE); Jens Storre, Noerten-Hardenberg (DE); Peter Metz, Korbach (DE)

(21) Appl. No.: 18/553,261

(22) PCT Filed: Mar. 16, 2022
(86) PCT No.: PCT/DE2022/200041

§ 371 Date: Sep. 29, 2023

(30) Foreign Application Priority Data
Apr. 1, 2021 (DE) 10 2021 203 368.7

(51) Int. Cl. B32B 25/10; B32B 1/08; B32B 5/02; B32B 25/14; B32B 37/06; B32B 37/16; B32B 38/00

(52) U.S. Cl. CPC B32B 25/10; B32B 1/08; B32B 5/02; B32B 25/14; B32B 37/06; B32B 37/16; B32B 38/00; B32B 2038/0084; B32B 2250/04; B32B 2264/108; B32B 2264/203; B32B 2305/022; B32B 2307/3065; B32B 2313/04; B32B 2319/00; B32B 2433/04; B32B 2597/00

(57) ABSTRACT

An article having a multilayer base unit with elastic properties has at least one inner layer A and at least one textile reinforcement layer B and at least one intermediate layer C and at least one outer layer D, at least one intermediate layer C of the base unit being formed from a rubber compound that includes chloroprene rubber (CR) or chlorosulfonated polyethylene (CSM) or alkylated chlorosulfonated polyethylene (ACSM) or chlorinated polyethylene (CM) or chlorobutyl rubber (CIIR) or bromobutyl rubber (BIIR) or polyepichlorohydrin rubber (CO; ECO; ETER) or brominated copolymer of isobutylene and paramethylstyrene (BIMS), in each case alone or in combination, and 3 to 40 phr of at least one intumescent flame retardant, and the intermediate layer C being in direct contact with a textile reinforcement layer B.

### RELATED APPLICATIONS

This application is a national phase of International Application No. PCT/DE2022/200041 filed Mar. 16, 2022, which claims priority to German Application No. 10 2021 203 368.7 filed Apr. 1, 2021, each of which is incorporated herein by reference in its entirety.

### TECHNICAL FIELD

The invention relates to an article having a multilayered main body with elastic properties, in particular an air spring bellows.

### BACKGROUND

Articles having elastic properties that are used in the suspension of, for example, motor vehicles or rail vehicles and/or for vibration damping are produced using elastomeric compounds, also known as rubber compounds. These elastomeric compounds commonly employed for the basic properties of such articles are well known. Articles having excellent elastic properties, for example metal-rubber elements or vibration dampers, preferably comprise vulcanized rubber compounds predominantly based on natural rubber (NR) and/or polyisoprene rubber (IR). Articles having very good resistance to weathering, mineral oil, and heat, for example air spring bellows, preferably comprise vulcanized rubber compounds predominantly based on chloroprene rubber (CR).

However, articles comprising such elastomeric compounds display distinct disadvantages in their fire behavior. In the event of fire, dense fumes are inter alia evolved. In the combustion process of the above elastomeric compounds predominantly based on NR and/or IR, the rate of heat release is particularly high. The fumes given off in the combustion process of elastomeric compounds based predominantly on CR are toxic to humans and animals.

The ratcheting up of fire-protection requirements in recent years, which is reflected in the stricter fire-protection standard EN45545 in particular, has given rise to an increased demand for polymer articles having optimized fire protection. These fire safety requirements are no longer able to be met either by the above elastomeric compounds predominantly based on NR and/or IR, in particular because of the required maximum rate of heat release, or by flame-resistant elastomeric compounds predominantly based on CR, particularly because of the required combustion fumes toxicity. Articles comprising these elastomeric compounds accordingly usually no longer meet the stricter requirements.

A customary method of improving the fire behavior of rubber compounds is the direct incorporation of fire-retardant substances. In order to achieve adequate fire protection with classical rubber compounds, a large amount of these fire-retardant substances is needed, which usually has a negative effect on physical properties. Experience has shown that the hardness of such compounds is too high for use in dynamic applications. The disadvantage of a significantly higher Shore A hardness when using sepiolite, as described for example in WO2018/033267 A1, is particularly evident in rubber compounds based on CR/NR. The articles concerned often have a reduced service life and poorer suspension, settling or vibration properties.

DE 10 2013 017 570 A1 describes the fire-protection property of expandable graphite in the outer coating as a flame-retardant substance having less than 15 M-%, which is intended to partially cover a halogen-free elastomer body for vibration damping or suspension uses. This coating can be designed as a thermoplastic base or silicone or polyurethane and, when cured, have a layer thickness of between 0.5 and 5 mm and constitute a combination having one or more flame retardants.

EP 2196 492 B1 describes the fire-protection property of a halogen-free layer that covers the body to be protected and that has an elastomeric halogen-free binder and an elasticity of at least 20%. Both expandable graphite as a flame retardant and combinations with other customary flame retardants are described. The layer structure detailed therein is based on elasticity that decreases towards the outside and can also include an IR-reflecting material as a third layer.

US2017/0267260 A1 discloses a vibration-damping device, the elastomeric vibration-damping structure of which is at least partially covered by a fire-protection layer. The fire-protection layer is based on chloroprene rubber and magnesium hydroxide and/or aluminum trihydrate.

### SUMMARY

In the approaches mentioned, the protection takes place in the uppermost outer layers, irrespective of which vibration damper is being described. In very intense fires, internal reinforcements in multilayer base units for various areas of application melt and give rise to a strong release of energy when igniting, as well as suffering a loss of function.

The object of the invention is thus to provide a multilayer article distinguished by having an internal reinforcement that in the event of a fire either does not melt at all or melts only after a very substantial delay. At the same time, the article as a whole must meet the requirements described in the EN-45545 standard without there being a decline in the necessary physical properties of the article and/or without the complexity of the production process increasing.

This object is achieved in that the article having a multilayer base unit with elastic properties has at least one inner layer A and at least one textile reinforcement layer B and at least one intermediate layer C and at least one outer layer D, at least one intermediate layer C of the base unit being formed from a rubber compound that comprises chloroprene rubber (CR) or chlorosulfonated polyethylene (CSM) or alkylated chlorosulfonated polyethylene (ACSM) or chlorinated polyethylene (CM) or chlorobutyl rubber (CIIR) or bromobutyl rubber (BIIR) or polyepichlorohydrin rubber (CO; ECO; ETER) or brominated copolymer of isobutylene and paramethylstyrene (BIMS), in each case alone or in combination, and 3 to 40 phr of at least one intumescent flame retardant, and the intermediate layer C being in direct contact with a textile reinforcement layer B.

Surprisingly, it has been found that the internal textile reinforcement can, through the effect of the heat, be protected from igniting through the foaming of the intermediate layer C, as a poor heat-conducting material, the time of ignition of the reinforcement layer to be protected, being delayed by the temperature. This makes it possible, even when the outermost layer of the article has already been damaged in a fire, for the reinforcement to remain stable and thus for the article to retain a degree of emergency functionality for some time.

In addition to the intermediate layer C, further flame-retardant layers may also be present in various places in the article, as a result of which the overall thickness of the flame-retardant material to be incorporated can be reduced across all layers without having to accept losses in fire protection and other physical properties.

According to the invention, the intermediate layer C contains, in addition to one or more of the rubbers mentioned, 3 to 40 phr, preferably 5 to 30 phr, more preferably 10 to 25 phr, of at least one intumescent flame retardant.

Intumescent flame retardants swell into foams under the influence of temperature, thereby forming a protective layer. The formation of the protective layer can occur through both chemical and physical processes. A chemical process normally necessitates three components:
a) polyphosphate, for example ammonium polyphosphate,
b) carbon sources, for example dipentaerythritol,
c) blowing agent, for example melamine, that gives off gaseous decomposition products when heated.

When heated, the carbon source and the polyphosphate give rise to carbon-rich decomposition products that, with the aid of gaseous decomposition products of, for example, melamine, undergo foaming into a highly viscous protective layer.

Preference is however given to using an intumescent flame retardant in which the protective layer is formed by a physical process. This reduces the addition of other chemicals to the rubber compound and thus reduces any further negative impact on other physical properties. Preference is given to using expandable graphite, also referred to as intumescent graphite, as the physically acting intumescent flame retardant.

The use here of just one expandable graphite is preferable. It is however also possible for a mixture of two or more different expandable graphites to be present. The difference can arise from different average particle sizes and/or different onset temperatures of the individual graphites.

It is advantageous when the expandable graphite or mixture of two or more expandable graphites has an onset temperature above 180° C., preferably above 200° C., more preferably above 220° C.

In a preferred embodiment, the rubber compound of the intermediate layer C is free of other flame retardants, in particular free of halogen-containing flame retardants. Free in this context means that the amount is 0 phr.

However, it is also possible for at least one further flame retardant to also be present in the intermediate layer C in addition to the intumescent flame retardant.

These may preferably be stannates, such as zinc stannate or zinc hydroxystannate, further hydroxides, such as magnesium hydroxide or calcium hydroxide, cyanurates, such as melamine cyanurate, borates, such as zinc borate or calcium borate, phosphorus-containing components, such as resorcinol diphosphate, melamine phosphate or aromatic polyphosphates, nitrogen-containing components, such as ammonium phosphate, or carbonates, such as calcium carbonate or magnesium carbonate.

In a preferred embodiment, the rubber compound of the intermediate layer C is free of further rubbers aside from those mentioned according to the invention, i.e. the amount of further rubbers is 0 phr.

In a particularly preferred embodiment, the rubber compound of the intermediate layer C comprises 50 to 100 phr, preferably 60 to 100 phr, more preferably 80 to 100 phr, of the rubbers mentioned in claim 1 alone or in combination.

In this case it is possible for the rubber compound to contain 0 to 50 phr, preferably 0 to 40 phr, more preferably 0 to 20 phr, of at least one further rubber, based on the total amount of these further rubbers.

This further rubber is preferably selected from the group consisting of ethylene-propylene copolymer (EPM) and ethylene-propylene-diene copolymer (EPDM) and nitrile rubber (NBR) and (partially) hydrogenated nitrile rubber (HNBR) and carboxylated nitrile-butadiene rubber (XNBR) and fluorine rubber (FKM) and natural rubber (NR) and styrene-butadiene rubber (SBR) and isoprene rubber (IR) and butyl rubber (IIR) and butadiene rubber (BR) and ethylene-vinyl acetate rubber (EVA) and acrylate rubber (ACM) and ethylene-acrylate rubber (AEM) and silicone rubber (MQ, VMQ, PVMQ, FVMQ) and fluorinated methyl silicone rubber (MFQ) and perfluorinated propylene rubber (FFPM) and perfluorocarbon rubber (FFKM) and polyurethane (PU). The further rubbers mentioned may be used alone or in combination.

As the name suggests, layer C is an intermediate layer, which means that it forms neither the outer layer nor the inner layer of the article, but is situated between the inner layer and the outer layer.

According to the invention, it is important that the intermediate layer C is in direct contact with the reinforcement layer B. The intermediate layer C can here enclose the reinforcement layer B partially or completely.

Depending on the shape of the article, it is also possible for the reinforcement layer to be covered with layer C on one or both sides, in the sense that layer C is present only on one side or on both sides of the reinforcement layer B.

In the case of coverage on just one side and likewise in the case of partial or complete enclosure, this preferably occurs in the direction of the expected heat exposure.

Additionally present according to the invention is at least one layer B that is formed from at least one textile reinforcement and is accordingly referred to as a reinforcement layer. The textile reinforcement layer can here have a single-layer, double-layer or multilayer structure.

It is preferably a cord fabric composed of preferably two layers that has good adhesion to each of the adjoining layers.

Materials used for the textile reinforcement layer B may be any known synthetic and natural materials alone or in combination, i.e. in the form of a hybrid fabric.

Suitable synthetic materials include in particular synthetic polymers, for example acrylonitrile, polyacrylonitrile, polypropylene, polyester, polyamide, polyurethane, polyphenylene sulfide, polyoxadiazole, aramids, such as p-aramid, m-aramid or copoly-para-aramid, polyimide, polyetherimide, polyetheretherketone, polyethylene 2,6-naphthalate, polyphenylene, polyphenylene oxide, polyphenylene sulfide, polyphenylene ether, polybenzoxazoles, and polyvinyl alcohol.

Natural materials may be rock wool or asbestos, or cotton, flax or hemp, or wool or silk.

Inorganic materials such as glass, ceramic, carbon, metal, for example steel, or stone, for example basalt, are likewise conceivable.

Preference is given to polyamide, especially PA 6,6, or polyester, alone or in combination.

For achievement of sufficient processing tackiness during the process for production of the article, the cord fabric may have been rubberized on one or both sides, for example by coating, frictionizing, brushing, knife-coating, or the like.

In order not to increase complexity in the production process further, it is advantageous when the rubber coating (also referred to as the friction layer) has the same qualitative and quantitative composition as the rubber compound of the intermediate layer C.

The presence of the intumescent flame retardant in the rubber layer too provides additional protection for the textile reinforcement layer B.

According to the invention, a further layer A is present that is referred to as the inner layer and forms what is known as the “inner cap” and is formed from an elastomeric compound and has particularly good elastic properties. The elastomeric compound is a vulcanizable, preferably thermoplastic-free, rubber compound comprising at least one rubber component as well as further compound ingredients. Suitable rubber components include in particular: ethylene-propylene rubber (EPM), ethylene-propylene-diene monomer rubber (EPDM), nitrile rubber (NBR), (partially) hydrogenated nitrile rubber (HNBR), carboxylated nitrile-butadiene rubber (XNBR), fluorine rubber (FKM), chloroprene rubber (CR), natural rubber (NR), styrene-butadiene rubber (SBR), isoprene rubber (IR), butyl rubber (IIR), bromobutyl rubber (BIIR), chlorobutyl rubber (CIIR), brominated copolymer of isobutylene and para-methylstyrene (BIMS), butadiene rubber (BR), chlorinated polyethylene (CM), chlorosulfonated polyethylene (CSM), alkylated chlorosulfonated polyethylene (ACSM), polyepichlorohydrin rubbers (CO; ECO; ETER), ethylene-vinyl acetate rubber (EVA), acrylate rubber (ACM), ethylene-acrylate rubber (AEM), silicone rubber (MQ, VMQ, PVMQ, FVMQ), fluorinated methyl silicone rubber (MFQ), perfluorinated propylene rubber (FFPM), perfluorocarbon rubber (FFKM), and polyurethane (PU).

The abovementioned rubber types may be unblended. The use of a blend is also possible.

The preferred rubber type depends on the article type and the demands on the individual article. The customary compound ingredients comprise at least one crosslinker or a crosslinker system (crosslinking agent and accelerator). Additional compound ingredients normally include at least one more filler and/or at least one processing aid and/or at least one plasticizer, for example phosphoric ester plasticizers, and/or at least one aging stabilizer and optionally further additives (for example color pigments, reinforcing fibers).

Reference is made in this regard to the general prior art in rubber compound technology.

The outer layer D forms what is called the “outer cap” of the article. The layer D may have a single-layer or double-layer structure. The elastomeric compound of the layer D is a vulcanizable, preferably thermoplastic-free, rubber compound comprising at least one rubber component and further compound ingredients. Suitable rubber components include in particular: ethylene-propylene rubber (EPM), ethylene-propylene-diene monomer rubber (EPDM), nitrile rubber (NBR), (partially) hydrogenated nitrile rubber (HNBR), carboxylated nitrile-butadiene rubber (XNBR), fluorine rubber (FKM), chloroprene rubber (CR), natural rubber (NR), styrene-butadiene rubber (SBR), isoprene rubber (IR), butyl rubber (IIR), bromobutyl rubber (BIIR), chlorobutyl rubber (CIIR), brominated copolymer of isobutylene and para-methylstyrene (BIMS), butadiene rubber (BR), chlorinated polyethylene (CM), chlorosulfonated polyethylene (CSM), alkylated chlorosulfonated polyethylene (ACSM), polyepichlorohydrin rubbers (CO; ECO; ETER), ethylene-vinyl acetate rubber (EVA), acrylate rubber (ACM), ethylene-acrylate rubber (AEM), silicone rubber (MQ, VMQ, PVMQ, FVMQ), fluorinated methyl silicone rubber (MFQ), perfluorinated propylene rubber (FFPM), perfluorocarbon rubber (FFKM), and polyurethane (PU).

The abovementioned rubber types may be unblended. The use of a blend is also possible.

The preferred rubber type depends on the nature of the article.

With regard to fire protection, favoring the use of halogen-containing rubber components, such as CR or ACSM or blends of CR and NBR (CR/NBR) or CR and NR (CR/NR), in the outer layer D affords clear advantages.

The customary compound ingredients comprise at least one crosslinker or a crosslinker system (crosslinking agent and accelerator). Additional compound ingredients normally include a further filler and/or a processing aid and/or a plasticizer and/or an aging stabilizer and also optionally further additives (for example color pigments, adhesion promoters, flame retardants, reinforcing fibers).

Reference is made in this regard to the general prior art in rubber compound technology.

The article is preferably an air spring bellows.

The article may alternatively be a tubular body. Tubular bodies are, for example, feed hoses of any kind, air spring bellows (cross-ply bellows, axial bellows) and compensators of various design (for example a torsion compensator or lateral compensator). The article may likewise be a drive belt.

### DETAILED DESCRIPTION

The invention is now elucidated further on the basis of working examples with reference to schematic drawings and laboratory experiments. The invention is not limited to these exemplary embodiments. Shown below:

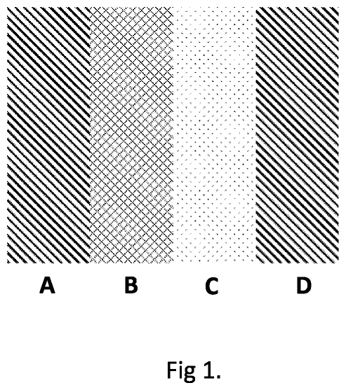

FIG. 1 shows an exemplary layer structure of an article, preferably an air spring, a vibration damper or a damping element.

The article includes a multilayer base unit with elastic properties having at least one inner layer A and at least one textile reinforcement layer B and at least one intermediate layer C and at least one outer layer D. The intermediate layer C according to the invention is here situated between the reinforcement layer B and the outer layer D.

In Table 1 the upper section shows the composition of a layer C that is in direct contact with a reinforcement layer B. The lower section shows the corresponding laboratory data. V1 represents a reference compound without expandable graphite. E1 and E2 are each compositions according to the invention with expandable graphite.

TABLE 1

| | | |
|---|---|---|
| V1 | E1 | E2 |

Composition of the compound

| | | | | |
|---|---|---|---|---|
| CR | phr | 100.00 | 100.00 | 100.00 |
| Carbon black | phr | 40.00 | 40.00 | 40.00 |
| Di-2-propylheptyl | phr | 8.00 | 8.00 | 8.00 |
| phthalate | | | | |
| ZnO | phr | 6.00 | 6.00 | 6.00 |
| Zinc stearate, | phr | 5.00 | 5.00 | 5.00 |
| stearic acid, wax | | | | |
| MgO | phr | 4.00 | 4.00 | 4.00 |
| MMBI | phr | 1.00 | 1.00 | 1.00 |
| Diarylphenyl- | phr | 3.00 | 3.00 | 3.00 |
| enediamine | | | | |
| Octylated | phr | 5.00 | 5.00 | 5.00 |
| diphenylamine | | | | |
| MBTS | phr | 1.00 | 1.00 | 1.00 |
| Expandable | phr | 0.00 | 12.00 | 24.00 |
| graphite | | | | |

Experimental results

| | | | | |
|---|---|---|---|---|
| Vulcanization | min/° C. | 30/160 | 30/160 | 30/160 |
| conditions | | | | |
| Density | g/ccm | 1.33 | 1.36 | 1.39 |
| (ISO 1183-1) | | | | |
| Hardness | Sh A | 58.0 | 60.0 | 63.0 |
| (ISO 7619-1) | | | | |
| Tensile strength | MPa | 18.1 | 14.2 | 10.4 |
| (ISO 37) | | | | |
| Elongation at | % | 618.2 | 511.4 | 425.9 |
| break (ISO 37) | | | | |
| 50% modulus | MPa | 1.2 | 1.3 | 1.4 |
| 100% modulus | MPa | 1.7 | 1.7 | 1.8 |
| 200% modulus | MPa | 3.7 | 3.6 | 3.6 |
| 300% modulus | MPa | 7.1 | 6.9 | 6.6 |
| 400% modulus | MPa | 10.56 | 10.38 | 9.76 |
| 500% modulus | MPa | 14.2 | 14 | — |
| Thickness: | mm | 5.7 | 2.47 | 2.41 |
| Initial mass: | g | 76.7 | 31.67 | 33.321 |
| Time to ignition: | sec | 157 | 56 | 55 |
| Time to flameout: | sec | 683 | 170 | 183 |
| Mass lost | g | 41.8 | 21.7 | 14.4 |
| Specific mass lost | kg/m² | | 2.46 | 1.62 |
| Percentage mass | % | 54.5 | 68.6 | 43.1 |
| lost | | | | |

1. An article comprising:
a multilayer base unit with elastic properties having at least one inner layer, at least one textile reinforcement layer, at least one intermediate layer, and at least one outer layer,
wherein the at least one intermediate layer of the multilayer base unit is formed from a rubber compound that comprises:
one or more of chloroprene rubber (CR) or chlorosulfonated polyethylene (CSM) or alkylated chlorosulfonated polyethylene (ACSM) or chlorinated polyethylene (CM) or chlorobutyl rubber (CIIR) or bromobutyl rubber (BIIR) or polyepichlorohydrin rubber (CO; ECO; ETER) or brominated copolymer of isobutylene and paramethylstyrene (BIMS), and
3 to 40 phr of at least one intumescent flame retardant,
wherein the at least one intermediate layer is in direct contact with the at least one textile reinforcement layer.

2. The article according to claim 1, wherein the total amount of CR, CSM, ACSM, CM, CIIR, BIIR, CO, ECO, ETER, BIMS, in each case alone or in combination, is between 50 and 100 phr.

3. The article according to claim 2, wherein the total amount of CR, CSM, ACSM, CM, CIIR, BIIR, CO, ECO, ETER, BIMS, in each case alone or in combination, is 100 phr.

4. The article according to claim 1, wherein the at least one intumescent flame retardant is an expandable graphite or a mixture of two or more different expandable graphites.

5. The article according to claim 1, wherein the article is an air spring bellows, a tubular body or a drive belt.

6. The article according to claim 1, wherein the article as a whole satisfies the requirements of the EN-45545 standard.

7. The article according to claim 1, wherein the at least one intumescent flame retardant is present in an amount from 5 to 30 phr.

8. The article according to claim 1, wherein the at least one intumescent flame retardant is present in an amount from 10 to 25 phr.

9. The article according to claim 1, wherein the at least one intumescent flame retardant is a physically acting intumescent flame retardant.

10. The article according to claim 1, wherein the rubber compound is free from chemically acting intumescent flame retardant.

11. The article according to claim 1, wherein the rubber compound is free from halogen-containing flame retardant.

12. The article according to claim 1, wherein the at least one intumescent flame retardant is only an intumescent expandable graphite in the amount from 3 to 40 phr, and the rubber compound is void of other flame retardant material.

13. The article according to claim 1, wherein the at least one intumescent flame retardant includes a intumescent expandable graphite having an onset temperature above 180° C.

14. The article according to claim 1, wherein the at least one intumescent flame retardant includes a physically acting intumescent expandable graphite having an onset temperature above 200° C.

15. The article according to claim 1, wherein the at least one intumescent flame retardant includes a physically acting intumescent expandable graphite having an onset temperature above 220° C.

16. A method of forming an article, comprising:
providing a layer formed from a rubber compound that comprises:
(i) one or more of chloroprene rubber (CR) or chlorosulfonated polyethylene (CSM) or alkylated chlorosulfonated polyethylene (ACSM) or chlorinated polyethylene (CM) or chlorobutyl rubber (CIIR) or bromobutyl rubber (BIIR) or polyepichlorohydrin rubber (CO; ECO; ETER) or brominated copolymer of isobutylene and paramethylstyrene (BIMS), and
(ii) 3 to 40 phr of at least one intumescent flame retardant;
heating the layer to an onset temperature of the at least one intumescent flame retardant that causes the layer to foam; and
forming an article with the layer as at least one intermediate layer, wherein:
the article includes a multilayer base unit with elastic properties having at least one inner layer, at least one textile reinforcement layer, the at least one intermediate layer, and at least one outer layer,
wherein the at least one intermediate layer is in direct contact with the at least one textile reinforcement layer.

17. The method according to claim 16, wherein the at least one intumescent flame retardant includes an intumescent expandable graphite having an onset temperature above 180° C.
